(19) United States
(12) Patent Application Publication
(10) Pub. No.: US 2020/0410480 A1
(43) Pub. Date: Dec. 31, 2020

(54) METHOD AND SYSTEM FOR PREDICTING CRYPTOCURRENCY PRICE USING ARTIFICIAL INTELLIGENCE

(71) Applicant: Chang Ho KWEON, Gyeonggi-do (KR)

(72) Inventor: Chang Ho KWEON, Gyeonggi-do (KR)

(21) Appl. No.: 16/572,933

(22) Filed: Sep. 17, 2019

(30) Foreign Application Priority Data
Jun. 27, 2019 (KR) 10-2019-0077130

(51) Int. Cl. G06Q 20/36; G06Q 30/02

(52) U.S. Cl. CPC G06Q 20/3678; G06Q 2220/00; G06Q 30/0283

(57) ABSTRACT

A method and system for predicting a cryptocurrency price using artificial intelligence. The cryptocurrency price prediction method includes the steps of: receiving information on each cryptocurrency from a cryptocurrency exchange server through an API and extracting a plurality of price data, by a data extraction unit; processing and storing the extracted price data in a storage unit, by a data refinement unit; creating a dataset configured of a mean and a standard deviation of each cryptocurrency, by a dataset construction unit; and creating a model using a dataset read function of each cryptocurrency, by a modeling unit.

### FIELD

The present invention relates to a method and system for predicting a cryptocurrency price using artificial intelligence, and particularly, to a method and system for creating a dataset by purifying cryptocurrency price data received from a cryptocurrency exchange and predicting and verifying the cryptocurrency price through a regression analysis.

### BACKGROUND

Investment in stocks is actively made through online owing to advancement in information communication technologies, and particularly, the volume of transactions made by individual investors remarkably increases. The reason that the individual investors frequently fail to invest in stocks is due to inability of correctly analyzing charts, as well as lack of information. Individual investors only simply utilize provided supplementary indicators and suffer from difficulties in predicting prices for successful investment.

As prior techniques, the “Method for forecasting stock price using a multiple regression analysis method” (Korean Patent Registration No. 10-0557576) only discloses a method of predicting individual stock prices, as well as stock price indexes, by calculating the effect of daily fluctuations in US stock prices on the stock prices in Korea (Japan, China, Hong Kong or Europe) as a numerical value using a multiple regression analysis method, and the “Method and system for predicting future stock price through analysis of total market value” (Korean Patent Registration No. 10-1508361) only discloses a method of creating an investment rule for mid- and long term stock price prediction by combining financial information and trends in stock prices using a knowledge engineering technique and a statistical technique.

(Patent document 1) Korean Patent Registration No. 10-0557476
(Patent document 2) Korean Patent Registration No. 10-1508361

### SUMMARY

Therefore, the present invention has been made in view of the above problems, and it is an object of the present invention to create a dataset by purifying cryptocurrency price data received from a cryptocurrency exchange, and predict and verify a cryptocurrency price through a regression analysis.

To accomplish the above object, according to one aspect of the present invention, there is provided a method of predicting a cryptocurrency price using artificial intelligence, the method comprising the steps of: receiving information on each cryptocurrency from a cryptocurrency exchange server through an API and extracting a plurality of price data, by a data extraction unit; processing and storing the extracted price data in a storage unit, by a data refinement unit; creating a dataset configured of a mean and a standard deviation of each cryptocurrency, by a dataset construction unit; and creating a model using a dataset read function of each cryptocurrency, by a modeling unit.

According to another aspect of the present invention, there is provided a system for predicting a cryptocurrency price using artificial intelligence, the system comprising: a data extraction unit for receiving information on each cryptocurrency from a cryptocurrency exchange server through an API and extracting a plurality of price data; a data refinement unit for processing and storing the extracted price data in a storage unit; a dataset construction unit for creating a dataset configured of a mean and a standard deviation of each cryptocurrency; and a modeling unit for creating a model using a dataset read function of each cryptocurrency.

### BRIEF DESCRIPTION OF THE DRAWINGS

FIG. 1 is a view showing the configuration of a cryptocurrency price prediction system according to an embodiment of the present invention.

FIG. 2 is a view showing the configuration of a cryptocurrency price prediction server according to an embodiment of the present invention.

FIGS. 3 and 4 are flowcharts illustrating a cryptocurrency price prediction method according to an embodiment of the present invention.

FIG. 5 is a view showing a cryptocurrency dataset according to an embodiment of the present invention.

FIG. 6 is a graph showing a result of price prediction for each cryptocurrency according to an embodiment of the present invention.

FIG. 7 is another graph showing a result of price prediction for each cryptocurrency according to an embodiment of the present invention.

FIG. 8 is another graph showing a result of price prediction for each cryptocurrency according to an embodiment of the present invention.

FIG. 9 is another graph showing a result of price prediction for each cryptocurrency according to an embodiment of the present invention.

### DETAILED DESCRIPTION

Specific structural or functional description with respect to the embodiments according to the concept of the present invention disclosed in this specification is merely exemplified for the purpose of describing the embodiments according to the concept of the present invention, and the embodiments according to the concept of the present invention may be embodied in a variety of forms and are not limited to the embodiments described in this specification.

As the embodiments according to the concept of the present invention allows diverse changes and may have various forms, the embodiments will be illustrated in the drawings and described in detail in this specification. However, this is not intended to limit the embodiments according to the concept of the present invention to specific disclosed forms, and it is to be appreciated that all changes, equivalents, and substitutes that do not depart from the spirit and technical scope of the present invention are encompassed in the present invention.

The terms used herein are used only to describe particular embodiments and are not intended to limit the present invention. Singular expressions include plural expressions, unless the context clearly indicates otherwise. It will be further understood that the terms “include”, “have” and the like used herein is to specify the presence of stated features, integers, steps, operations, elements, and/or components, but do not preclude in advance the presence or addition of one or more other features, integers, steps, operations, elements, components, and/or groups thereof.

Hereinafter, the embodiments of the present invention will be described in detail with reference to the accompanying drawings.

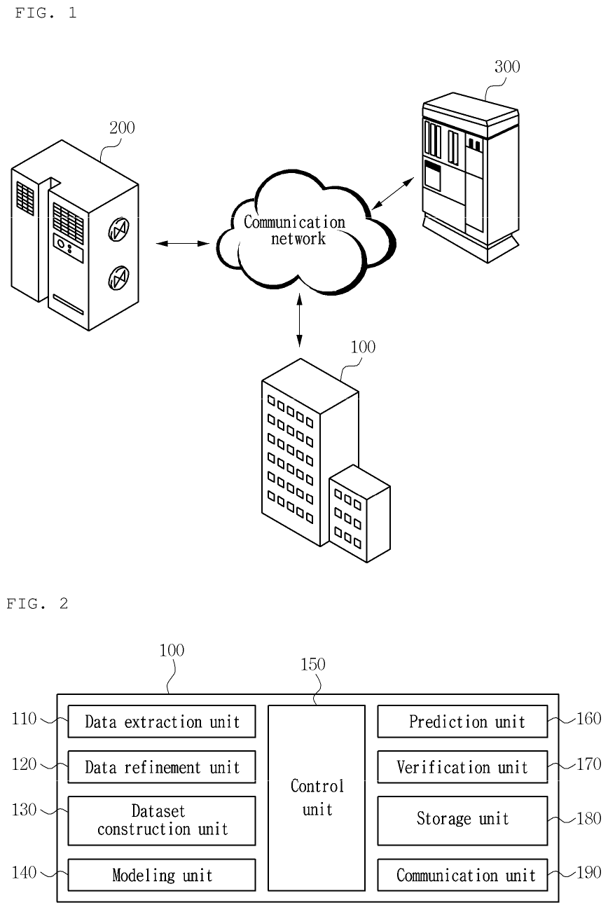

FIG. 1 is a view showing the configuration of a cryptocurrency price prediction system according to an embodiment of the present invention.

Referring to FIG. 1, a cryptocurrency price prediction system is configured of a price prediction server 100, a cryptocurrency exchange server 200, and a database server 300, capable of communicating with each other through a wireless communication network. The wireless communication network may be configured of diverse communication networks, such as a local area network (LAN), a metropolitan area network (MAN), a wide area network (WAN) and the like.

The price prediction server 100 may receive information on each cryptocurrency from the cryptocurrency exchange server 200 and predict a cryptocurrency price by extracting and processing a price data. The cryptocurrency exchange server 200 may transmit information on each cryptocurrency managed by the server to the price prediction server 100. The price prediction server 100 may receive a reference data from the database server 300 and purify the price data.

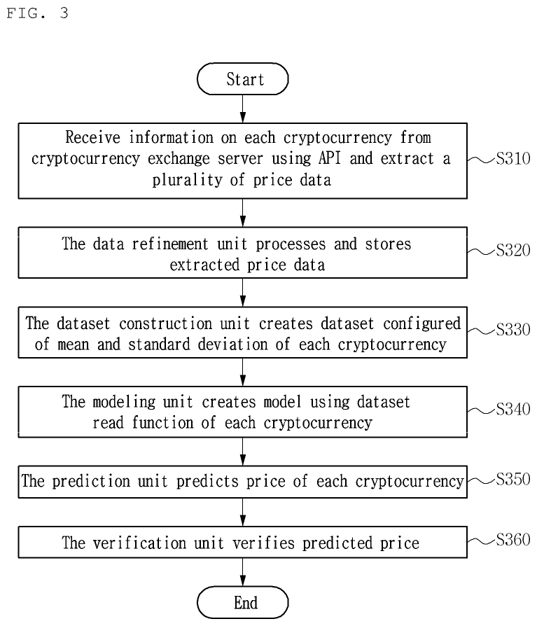

FIG. 2 is a view showing the configuration of a cryptocurrency price prediction server according to an embodiment of the present invention.

Referring to FIG. 2, the cryptocurrency price prediction server 100 is configured of a data extraction unit 110, a data refinement unit 120, a dataset construction unit 130, a modeling unit 140, a control unit 150, a prediction unit 160, a verification unit 170, a storage unit 180, and a communication unit 190.

The data extraction unit 110 may receive information on each cryptocurrency from the cryptocurrency exchange server 200 using an API and extract a plurality of price data. At this point, as the information on each cryptocurrency, the data extraction unit 110 may receive at least one among information on the last transaction of the cryptocurrency exchange, detailed information on transactions pending registration of sales and purchase at the exchange or transactions currently in progress, detailed information on transactions that has been completed at the exchange, and index information using a public API, and may receive at least one among membership information, wallet information, a deposit address, last transaction information, detailed information on registration of sales and purchase transaction orders or transactions currently in progress, information on registration of sales and purchase transaction orders and transactions that has been completed, detailed information on completed sales and purchases, and information on cancellation of sales and purchase transactions using a private API.

The data extraction unit 110 may extract at least one among a starting transaction amount within the last 24 hours, a final transaction amount within the last 24 hours, a minimum transaction amount within the last 24 hours, a maximum transaction amount within the last 24 hours, a mean transaction amount within the last 24 hours, a currency transaction volume within the last 24 hours, a currency transaction volume within the last 7 days, a maximum purchase price of pending transactions, a minimum selling price of pending transactions, a 24-hour variation amount, a 24-hour variation rate, and a time stamp of current time on the basis of the received information.

The data refinement unit 120 may process and purify the extracted price data and store purified price data in the storage unit. At this point, the data refinement unit 120 may store the price data in an internal storage unit every 30 minutes using an API and may store the price data in the database server. For example, the data refinement unit 120 may construct a table using Mysql and store purified price data therein.

The dataset construction unit 130 may create a dataset configured of a mean and a standard deviation of each cryptocurrency on the basis of the purified price data. At this point, the 7-day transaction volume may have the least correlation with respect to the mean value. In addition, the minimum value may have the least correlation with respect to the mean value.

The modeling unit 140 may create a model using a dataset read function of each cryptocurrency. For example, although the dataset read function may be a Sklearn function, it is not limited thereto. At this point, since each cryptocurrency has a different price, a standard criterion is needed, and the Sklearn function is modeled using a MinMaxScaler function and may have a maximum value of +1 and a minimum value of −1.

The control unit 150 controls handling of a process related to execution of software operating in the price prediction server and controls operation of the components in the price prediction server 100.

On the basis of the modeling, the prediction unit 160 may predict a price of each cryptocurrency through a regression analysis using Tensorflow or Sklearn based on a machine learning SVM. At this point, the prediction unit may predict the price on the basis of a first interval. Although the first interval may be 4 hours, it is not limited thereto.

The verification unit 170 verifies the predicted price (step S360). At this point, the verification unit extracts the current price on the basis of a second interval. Although the second interval may be 30 minutes, it is not limited thereto. The verification unit may calculate a difference ratio between the predicted price and the current price and output a verification result.

The storage unit 180 may store the processed price data and the predicted price, and the communication unit 190 may transmit and receive information to and from the cryptocurrency exchange server 200 and the database server 300.

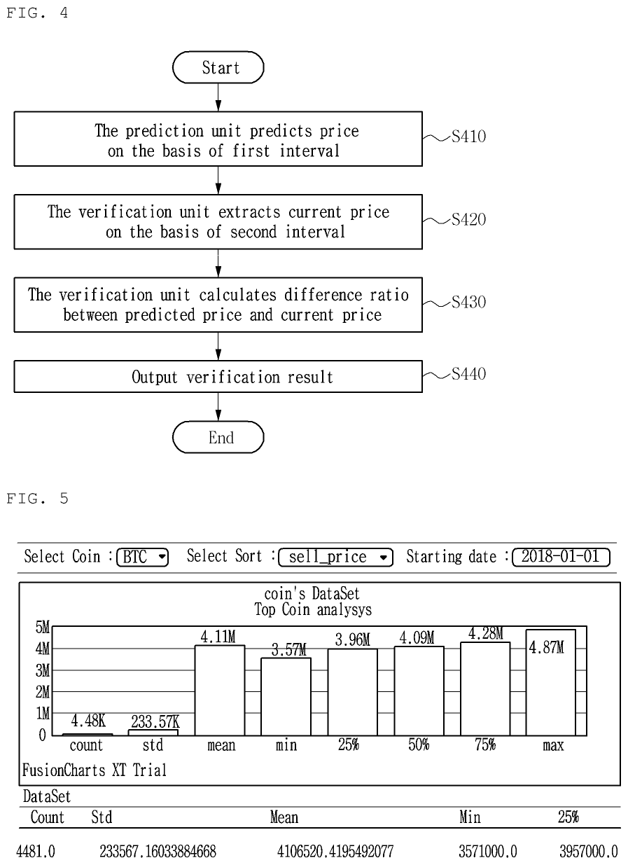

FIGS. 3 and 4 are flowcharts illustrating a cryptocurrency price prediction method according to an embodiment of the present invention.

Referring to FIGS. 3 and 4, in a cryptocurrency price prediction method according to an embodiment of the present invention, the data extraction unit 110 receives information on each cryptocurrency from the cryptocurrency exchange server 200 using an API and extracts a plurality of price data (step S310).

The data extraction unit 110 may receive at least one among information on the last transaction of the cryptocurrency exchange, detailed information on transactions pending registration of sales and purchase at the exchange or transactions currently in progress, detailed information on transactions that has been completed at the exchange, and index information using a public API, and may receive at least one among membership information, wallet information, a deposit address, last transaction information, detailed information on registration of sales and purchase transaction orders or transactions currently in progress, information on registration of sales and purchase transaction orders and transactions that has been completed, detailed information on completed sales and purchases, and information on cancellation of sales and purchase transactions using a private API.

The data extraction unit 110 may extract at least one among a starting transaction amount within the last 24 hours, a final transaction amount within the last 24 hours, a minimum transaction amount within the last 24 hours, a maximum transaction amount within the last 24 hours, a mean transaction amount within the last 24 hours, a currency transaction volume within the last 24 hours, a currency transaction volume within the last 7 days, a maximum purchase price of pending transactions, a minimum selling price of pending transactions, a 24-hour variation amount, a 24-hour variation rate, and a time stamp of current time on the basis of the received information.

The data refinement unit 120 extracts a price data by processing the extracted data and stores the price data in the storage unit (step S320). The data refinement unit 120 may input the price data in the database every 30 minutes using an API, and construct a table using Mysql and input purified price data therein.

The dataset construction unit 130 creates a dataset configured of a mean and a standard deviation of each cryptocurrency (step S330). The 7-day transaction volume may have the least correlation with respect to the mean value. In addition, the minimum value may have the least correlation with respect to the mean value.

The modeling unit 140 creates a model using a Sklearn function of each cryptocurrency (step S340). Since each cryptocurrency has a different price, a standard criterion is needed, and the Sklearn function is modeled using a MinMaxScaler function and may have a maximum value of +1 and a minimum value of −1.

The prediction unit predicts a price of each cryptocurrency through a regression analysis (step S350). At this point, the prediction unit may predict the price on the basis of a first interval.

The verification unit 170 verifies the predicted price (step S360). At this point, the verification unit extracts the current price on the basis of a second interval. The verification unit may calculate a difference ratio between the predicted price and the current price and output a verification result.

FIG. 5 is a view showing a cryptocurrency dataset according to an embodiment of the present invention.

Referring to FIG. 5, a dataset is configured of a mean and a standard deviation, and it is known through the graph that a large standard deviation means high volatility. For example, the standard deviation is large in order of Ripple, Bitcoin, EOS and Etherreum, and the volatility is high according thereto.

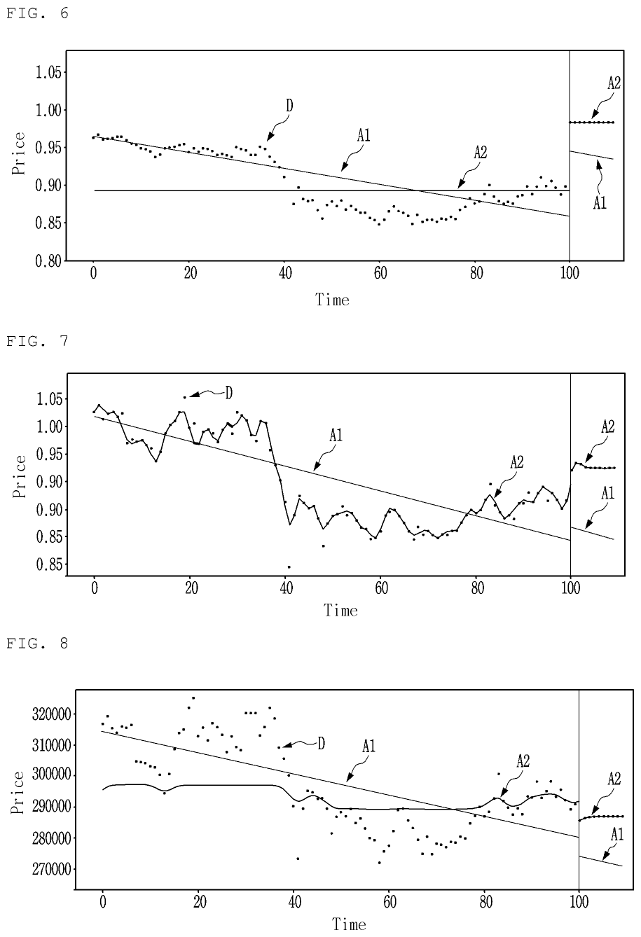

FIGS. 6 to 9 are graphs showing a result of price prediction for each cryptocurrency according to an embodiment of the present invention.

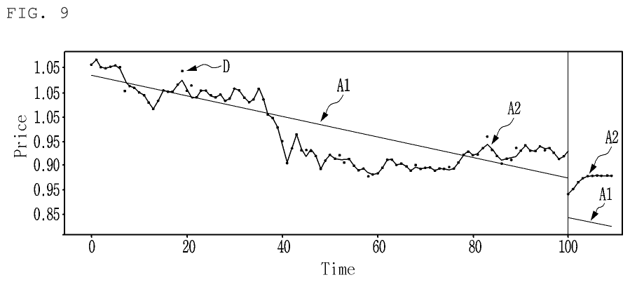

Referring to FIGS. 6 to 9, the graphs show a result of analysis and prediction conducted on May 18, 2019 on the Bitcoin (FIG. 6), EOS (FIG. 7), Ethereum (FIG. 8) and Ripple (FIG. 9), among the cryptocurrencies. The dots (D) are a graph showing real price data, and the graph (A1) is a graph analyzing and predicting a price by assigning a weighting value to a similarity rate of the volatility of each cryptocurrency. The graph (A2) is a price prediction based on linearity, and the graph (A2) is a price prediction using a radical basis function (RBF). Starting from 100, a price may be predicted by assigning a weighting value.

According to the present invention, a cryptocurrency price may be predicted by assigning a weighting value to a similarity rate of volatility of each cryptocurrency on the basis of an artificial intelligence technique.

Although the present invention has been described with reference to the embodiments shown in the figures, it is only illustrative and those skilled in the art may understand that various modifications and equivalent other embodiments are possible from the embodiments. Accordingly, the true scope of the present invention should be defined by the spirit of the appended claims.

What is claimed is:

1. A method of predicting a cryptocurrency price using artificial intelligence, the method comprising the steps of:
(a) receiving information on each cryptocurrency from a cryptocurrency exchange server through an API and extracting a plurality of price data, by a data extraction unit;
(b) processing and storing the extracted price data in a storage unit, by a data refinement unit;
(c) creating a dataset configured of a mean and a standard deviation of each cryptocurrency, by a dataset construction unit; and
(d) creating a model using a dataset read function of each cryptocurrency, by a modeling unit.

2. The method according to claim 1, further comprising the steps of:
(e) predicting a price of each cryptocurrency through a regression analysis, by a prediction unit; and
(f) verifying the predicted price, by a verification unit.

3. The method according to claim 2, wherein at steps (e) and (f), the prediction unit predicts the price on the basis of a first interval, and the verification unit extracts a current price on the basis of a second interval.

4. The method according to claim 3, wherein the verification unit calculates a difference ratio between the predicted price and the current price and outputs a verification result.

5. A system for predicting a cryptocurrency price using artificial intelligence, the system comprising:
a data extraction unit for receiving information on each cryptocurrency from a cryptocurrency exchange server through an API and extracting a plurality of price data;
a data refinement unit for processing and storing the extracted price data in a storage unit;
a dataset construction unit for creating a dataset configured of a mean and a standard deviation of each cryptocurrency; and
a modeling unit for creating a model using a dataset read function of each cryptocurrency.
